(19) United States
(12) Patent Application Publication
(10) Pub. No.: US 2017/0096212 A1
(43) Pub. Date: Apr. 6, 2017

(54) DRAG REDUCTION OF HIGH SPEED AIRCRAFT

(71) Applicant: Sikorsky Aircraft Corporation, Stratford, CT (US)

(72) Inventors: Razvan Virgil Florea, Manchester, CT (US); Patrick Bowles, Manchester, CT (US); Barbara Brenda Botros, Vernon, CT (US); ByungYoung Min, Glastonbury, CT (US); Claude G. Matalanis, Longmeadow, MA (US); Brian E. Wake, South Glastonbury, CT (US)

(21) Appl. No.: 15/206,546

(22) Filed: Jul. 11, 2016

Related U.S. Application Data
(60) Provisional application No. 62/217,444, filed on Sep. 11, 2015.

(51) Int. Cl. B64C 7/00; B64C 27/10

(52) U.S. Cl. CPC B64C 7/00; B64C 27/10

(57) ABSTRACT

A rotor hub fairing system for use in a counter-rotating, coaxial rotor system is provided including an upper hub fairing defined about an axis and a lower hub fairing defined about the axis. A shaft fairing is disposed between the upper hub fairing and the lower hub fairing. The geometry of the shaft fairing is configured to encourage a wake adjacent the upper hub fairing to form collectively with a wake adjacent the lower hub fairing.

### CROSS-REFERENCE TO RELATED APPLICATION

This application claims the benefit of U.S. provisional patent application Ser. No. 62/217,444 filed Sep. 11, 2015, the entire contents of which are incorporated herein by reference.

### STATEMENT REGARDING FEDERALLY SPONSORED RESEARCH OR DEVELOPMENT

This invention was made with Government support under Technology Investment Agreement No. W911W6-13-P-0010 with the United States Army. The Government has certain rights in the invention.

### BACKGROUND OF THE INVENTION

Exemplary embodiments of the invention relate to a rotor hub fairing system, and more particularly, to a rotor hub fairing system that reduces overall drag for a high speed rotary wing aircraft having a counter-rotating, coaxial rotor system.

Typically, aerodynamic drag associated with a rotor system of a rotary wing aircraft is a significant portion of the overall aircraft drag, commonly 25% to 30% for conventional single-rotor helicopters. The rotor system drag increases for a rotary wing aircraft having a counter-rotating coaxial system primarily due to the additional rotor hub and the interconnecting main rotor shaft assembly between the upper and lower rotor systems. For high speed rotary-wing aircrafts, the increased drag resulting from the counter-rotating coaxial rotor system may cause a relatively significant power penalty and/or limit aircraft speed.

The aerodynamic drag of the dual counter-rotating, coaxial rotor system is generated by three main components—the upper hub, the lower hub, and the interconnecting main rotor shaft assembly. The drag contributions may be approximately 40% for each of the rotor hubs, and 20% for the interconnecting shaft assembly; however, the effects are highly interactional, i.e., flow separation over one component may result in more significant flow separation and higher drag on another component.

Fairings have been used in conventional rotary wing aircraft to reduce drag. The implementation of a fairing in an application having airfoils with a large thickness to chord ratio, however, is more complex because of the negative restoring moment that thick airfoils tend to exhibit. Failure to compensate for this may result in the need to incorporate a more complex mechanism and controller, thus, reducing the benefits of the fairing.

### BRIEF DESCRIPTION OF THE INVENTION

According to an embodiment, a rotor hub fairing system for use in a counter-rotating, coaxial rotor system is provided including an upper hub fairing defined about an axis and a lower hub fairing defined about the axis. A shaft fairing is disposed between the upper hub fairing and the lower hub fairing. The geometry of the shaft fairing is configured to encourage a wake adjacent the upper hub fairing to form collectively with a wake adjacent the lower hub fairing.

In addition to one or more of the features described above, or as an alternative, in further embodiments a horizontal cross-section of the shaft fairing is generally airfoil shaped.

In addition to one or more of the features described above, or as an alternative, in further embodiments the shaft fairing has a shape complementary to the upper hub fairing and the lower hub fairing.

In addition to one or more of the features described above, or as an alternative, in further embodiments the shaft fairing includes a top surface positioned adjacent the upper rotor hub and at least a portion of the top surface is angled downwardly.

In addition to one or more of the features described above, or as an alternative, in further embodiments the angled portion of the top surface begins at a portion of the top surface adjacent a periphery of the upper hub fairing.

In addition to one or more of the features described above, or as an alternative, in further embodiments wherein the shaft fairing includes a trialing edge extending aft of the upper hub fairing and the lower hub fairing. The angled portion of the top surface extends to the trailing edge such that an overall height of the shaft fairing at the trailing edge is less than an overall height of the shaft fairing between the upper hub fairing and the lower hub fairing.

In addition to one or more of the features described above, or as an alternative, in further embodiments the shaft fairing includes a trialing edge extending aft of the upper hub fairing and the lower hub fairing, at least a portion of the trailing edge being generally curved.

In addition to one or more of the features described above, or as an alternative, in further embodiments the shaft fairing includes a top surface positioned adjacent the upper rotor hub and a portion of the top surface adjacent the trailing edge curves generally downward towards the lower hub fairing.

According to another embodiment, a coaxial rotor system is provided including an upper rotor system including an upper rotor hub which rotates about an axis of rotation and a lower rotor system including a lower rotor hub which rotates about the axis of rotation. An upper hub fairing at least partially surrounds a portion of said upper rotor hub and a lower hub fairing at least partially surrounds a portion of said lower rotor hub. A shaft fairing is positioned between the upper hub fairing and the lower hub fairing. The geometry of the shaft fairing is configured to encourage a wake adjacent the upper hub fairing to form collectively with a wake adjacent the lower hub fairing.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIGS. 1A and 1B are general side views of an exemplary rotary wing aircraft for use with the present invention;

FIG. 2 is an expanded partial phantom view of a counter-rotating coaxial rotor system with a rotor hub fairing system;

FIG. 3 is an oblique aft perspective view of a conventional rotor hub fairing system;

FIG. 4 is a side view of a rotor hub fairing system with pressure contours from computational fluid dynamics simulations according to an embodiment; and

FIG. 5 is a side view of another rotor hub fairing system with pressure contours from computational fluid dynamics simulations according to an embodiment.

The detailed description explains embodiments of the invention, together with advantages and features, by way of example with reference to the drawings.

### DETAILED DESCRIPTION OF THE INVENTION

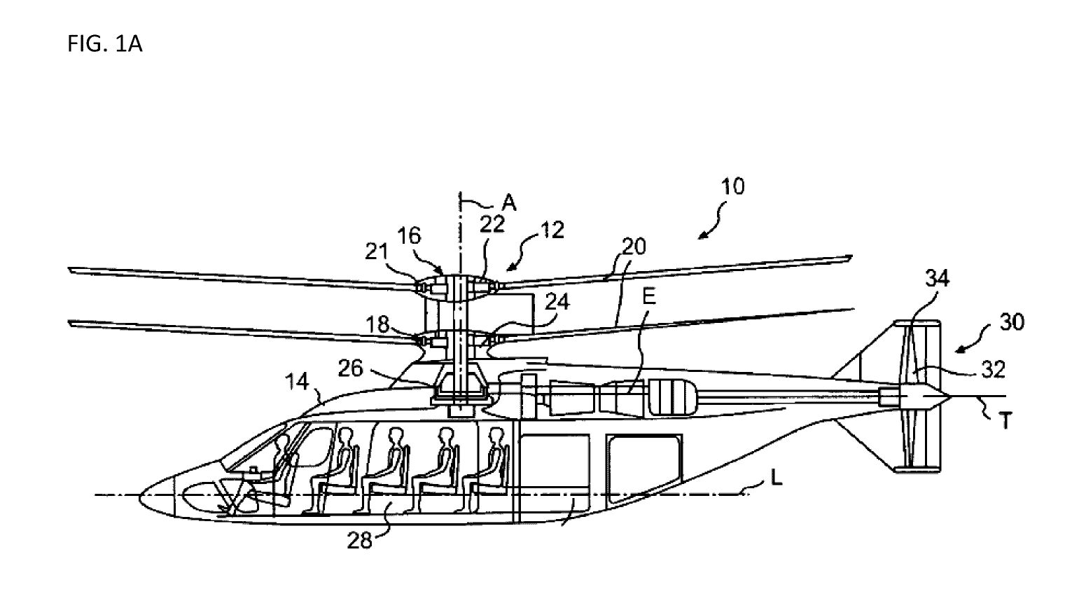

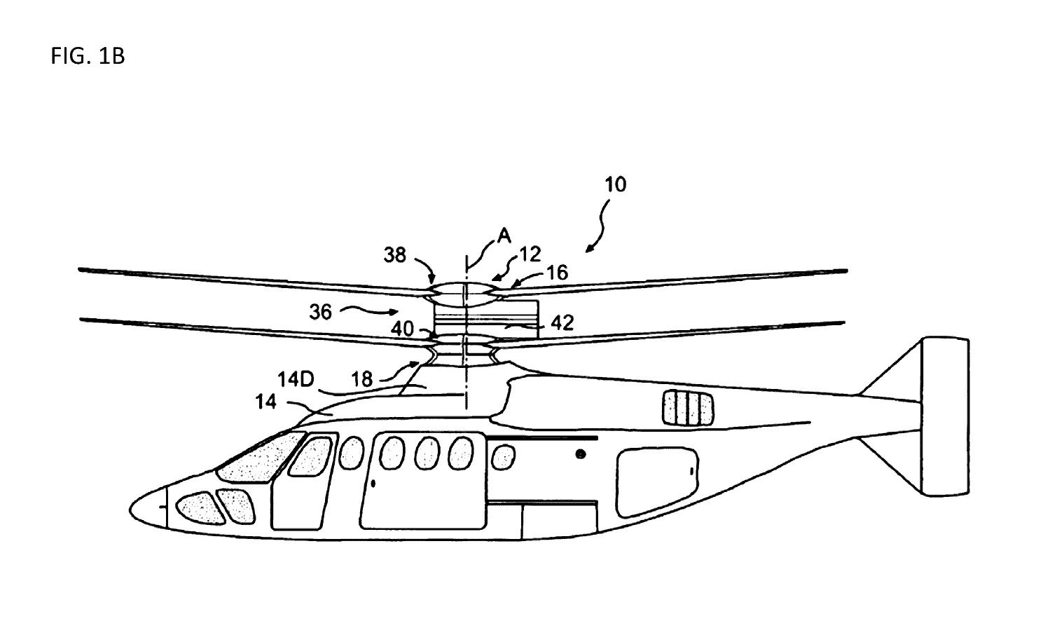

A high speed compound rotary-wing aircraft with a dual, contra-rotating, coaxial rotor system as shown in FIGS. 1A and 1B is capable of travel at higher speeds than conventional single rotor helicopters due in part to the balance of lift between the advancing side of the main rotor blades on the upper and lower rotor systems. In addition, the retreating sides of the rotors are also generally free from classic retreating blade stall that conventional single or tandem rotor helicopters may suffer from.

FIGS. 1A and 1B illustrate an exemplary high speed compound rotary wing aircraft 10 having a dual, counter-rotating, coaxial rotor system 12. The aircraft 10 includes an airframe 14 that supports the dual, counter-rotating, coaxial rotor system 12 as well as a translational thrust system 30 which provides translational thrust generally parallel to an aircraft longitudinal axis L. Although a particular aircraft configuration is illustrated, other rotary wing aircraft configurations are within the scope of the invention.

The dual counter-rotating, coaxial rotor system 12 includes a first rotor system 16, such as an upper rotor system for example, and a second rotor system 18, such as a lower rotor system for example. Each rotor system 16, 18 includes a plurality of rotor blades 20 mounted to a rotor hub assembly 22, 24 for rotation about a rotor axis of rotation A. The plurality of main rotor blades 20 project substantially radially outward from each of the hub assemblies 22, 24 and are connected thereto in any manner known to a person skilled in the art. Any number of rotor blades may be used with the dual counter-rotating, coaxial rotor system 12.

The dual, counter-rotating, coaxial rotor system may be driven by a main gearbox 26 located above the aircraft cabin. A translational thrust system 30 may be mounted to the rear of the airframe 14 with a rotational axis T oriented substantially horizontal and parallel to the aircraft longitudinal axis L to provide thrust for high-speed flight. In one embodiment, the translational thrust system 30 includes a pusher propeller 32 mounted within an aerodynamic cowling 34. The translational thrust system 30 may be driven by the same gearbox 26 that drives the rotor system 12. The main gearbox 26 is driven by one or more engines E and may be positioned between the gas turbine engines E and the translational thrust system 30.

Referring now to FIG. 1B, the rotor system 12 may also include a rotor hub fairing system 36 generally located between the upper and lower rotor systems 16, 18 such that the rotor hubs 22, 24 are at least partially contained therein. It is known that a significant portion of the overall aircraft drag on a vertical take-off and landing (VTOL) aircraft is due to the main rotor system 12. The rotor system drag increases for a rotary wing aircraft 10 having a counter-rotating, coaxial rotor system primarily due to the interconnecting rotor shaft assembly between the upper and lower rotor systems 16, 18. Additionally, the aerodynamic drag on a counter-rotating, coaxial rotor system 12 may be dominated by the pressure drag resulting from large-scale flow separation; typically the skin-friction drag may contribute only about 10% of overall aircraft drag. The rotor hub fairing system 36 achieves a significant drag reduction in which large scale flow separation is greatly reduced.

The rotor hub fairing system 36 includes an upper hub fairing 38, a lower hub fairing 40 and a shaft fairing 42 there between. The rotor hub fairing system 36 is sized and configured to reduce interference effects between the separate fairing components 38, 40, 42 and to minimize flow separation in the junction areas. In one embodiment, the lower hub fairing 40 is sized and configured to follow the contours of the airframe 14 in an area near a pylon 14D. The shaft fairing 42 may follow the contours of the upper hub fairing 38 and the lower hub fairing 40 at the rotational interfaces there between.

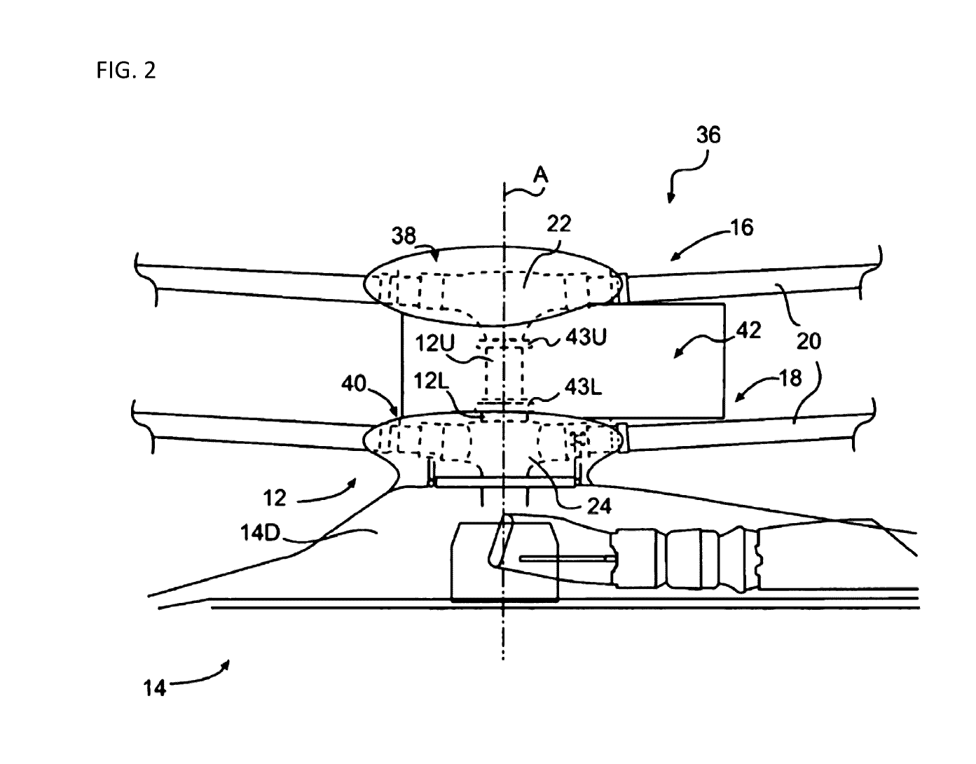

In one embodiment, illustrated in FIG. 2, the shaft fairing 42 is attached to the counter-rotating coaxial rotor system 12 through a bearing arrangement 43U, 43L such that the shaft fairing 42 is aligned with the relative wind in forward flight but is free to pivot about the axis A, such as during low speed maneuvering for example. The upper bearing 43U and the lower bearing 43L are respectively located adjacent an upper portion and a lower portion of the shaft fairing 42. The upper bearing 43U may attach to one rotor shaft while the lower bearing 43L may attach to the other rotor shaft such that the bearings 43U, 43L are counter-rotating and the net bearing drag is relatively low. Other mechanisms for attaching the shaft fairing 42 to the counter-rotating, coaxial rotor system 12 may be used.

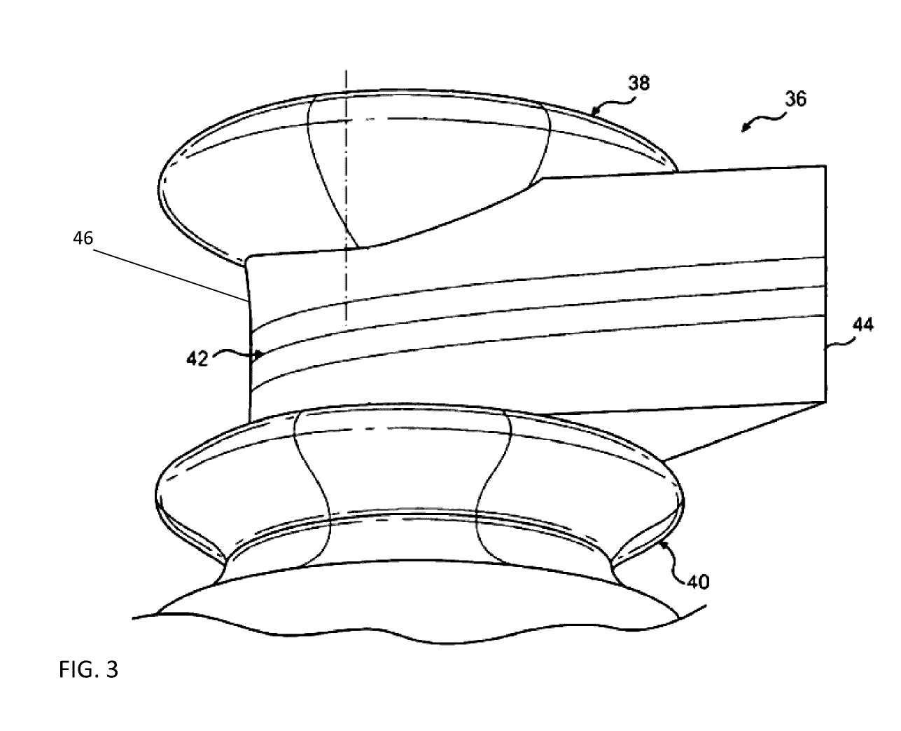

Referring to FIGS. 3-5, various examples of a rotor hub fairing system 36 are illustrated including upper and lower hub fairings 38, 40 having a generally elliptical cross-section. A horizontal cross-section of the shaft fairing 42 has a generally airfoil-type shape. The airfoil shape of the shaft fairing 42 includes a leading edge 46, and a trailing edge 44 aft of the upper and lower fairings 38, 40. The trailing edge 44 extends aft of a periphery defined by the upper hub fairing 38 and the lower hub fairing 40, thereby substantially reducing pressure drag. The airfoil shape of the shaft fairing 42 additionally includes a chord (not shown) that connects the leading and trailing edges 46, 44 of the airfoil. In one embodiment, the airfoil shape, including the upper surface 48 and the lower surface 50, is symmetrical about a plane extending along the length of the shaft fairing 42 and containing the axis of rotation.

When an aircraft 10 including a conventional rotor hub fairing system 36 (see FIG. 3) is in flight, typically an upper wake is formed behind the upper hub fairing 38 and a lower wake is formed behind the lower hub fairing 40. It is found that if the upper wake and the lower wake can be formed collectively by directing the upper wake downward towards the lower wake, an overall improvement in the total aircraft drag is achieved. It is therefore desirable to modify the geometry of the shaft fairing 42 such that the upper and lower wakes form collectively.

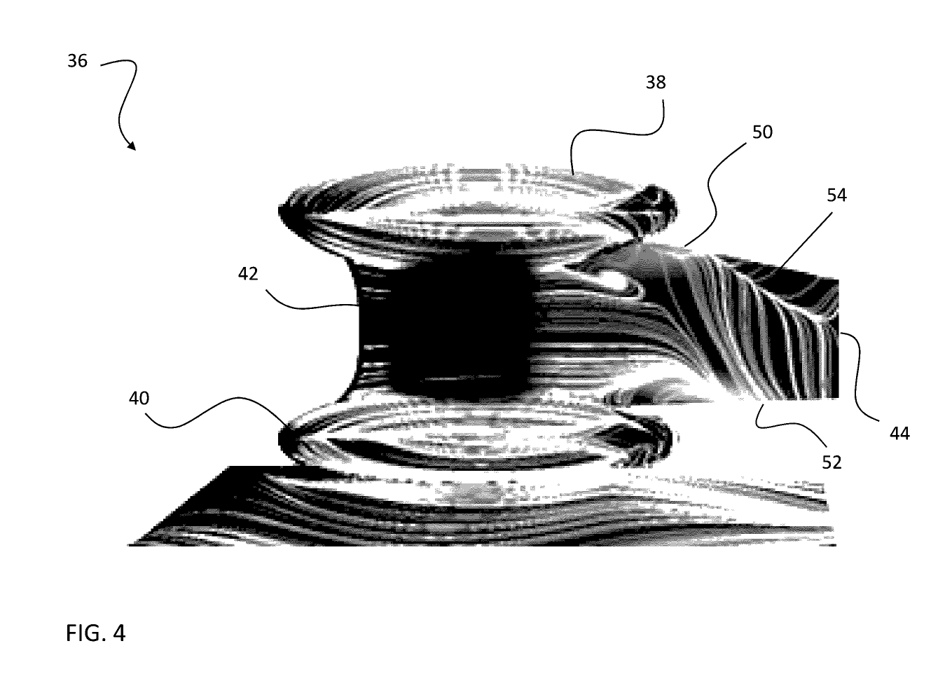

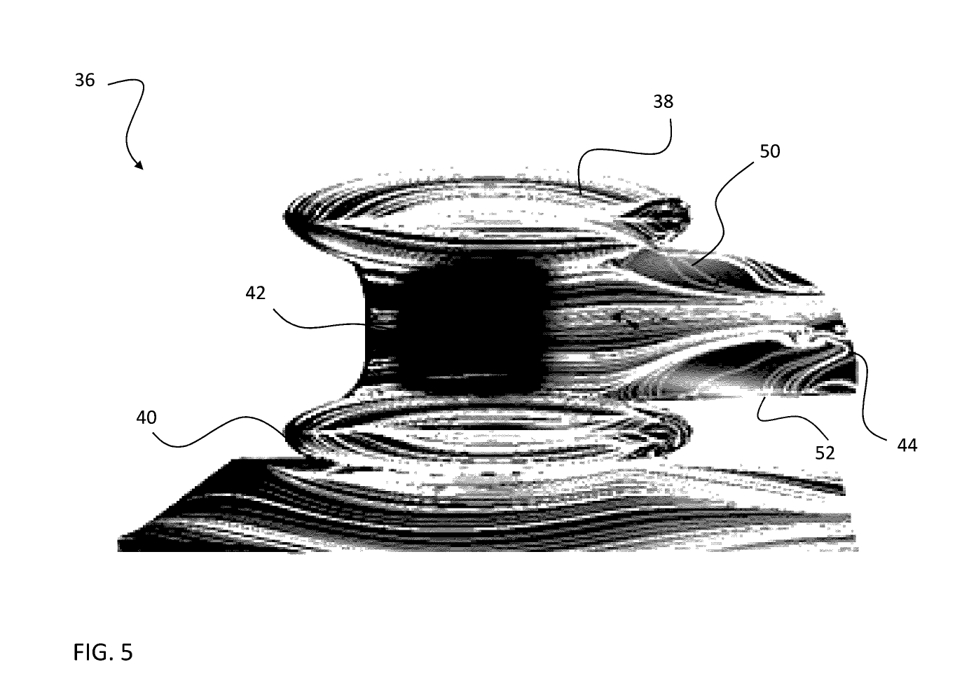

With reference to FIGS. 4 and 5, a shaft fairing 42 having a geometry modified to achieve a collective wake according to the disclosure is illustrated. In one embodiment, illustrated in FIG. 4, at least a portion of the surface 50 of the shaft fairing 42 positioned adjacent the upper rotor hub 38 is angled or sloped downwards towards the lower hub fairing 40 and an opposite surface 52 of the shaft fairing 42. As shown, the angled portion 54 of the top surface 50 may begin adjacent a periphery of the upper hub fairing 38 and extend to the trailing edge 44. In the illustrated, non-limiting embodiment, the overall height of the shaft fairing 42 at the trailing edge 44 is about 80% of the height of the shaft fairing 42 measured between the hub fairings 38, 40. However, shaft fairings 42 having a top surface 50 with varying degrees of slope are within the scope of the disclosure. In another embodiment, illustrated in FIG. 5, the trailing edge 44 of the shaft fairing 42 is generally curved. More specifically, the top surface 50 of the shaft fairing 42 adjacent the trailing edge 44 thereof may curve generally downward towards the bottom surface 52. As previously suggested, the origin of the curvature may begin generally adjacent the periphery of the upper hub fairing 38 and extend over at least a portion of the trailing edge 44.

The rotor hubs 22, 24 contribute significantly to the drag of an aircraft having a dual, counter-rotating, coaxial rotor system 12. The described modifications to the geometry of the top surface 50 and trailing edge 44 of the shaft fairing 42 encourage the wake formed behind the upper rotor hub fairing 38 to follow the contour of the shaft fairing 42 and drift towards the bottom surface 52 of the shaft fairing 42 and the fuselage 14. Such modifications improve the airflow around the upper rotor hub fairing 38 as well as the shaft fairing 42, resulting in reduced flow separation. The improvements in the airflow result in a drag reduction between about 5-7% during normal flight conditions.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A rotor hub fairing system for use in a counter-rotating, coaxial rotor system comprising:
an upper hub fairing defined about an axis;
a lower hub fairing defined about the axis; and
a shaft fairing disposed between the upper hub fairing and the lower hub fairing, wherein a geometry of the shaft fairing is configured to encourage a wake adjacent the upper hub fairing to form collectively with a wake adjacent the lower hub fairing.

2. The rotor hub fairing according to claim 1, wherein a horizontal cross-section of the shaft fairing is generally airfoil shaped.

3. The rotor hub fairing according to claim 1, wherein the shaft fairing has a shape complementary to the upper hub fairing and the lower hub fairing.

4. The rotor hub fairing according to claim 1, wherein the shaft fairing includes a top surface positioned adjacent the upper rotor hub and at least a portion of the top surface is angled downwardly.

5. The rotor hub fairing according to claim 4, wherein the angled portion of the top surface begins at a portion of the top surface adjacent a periphery of the upper hub fairing.

6. The rotor hub fairing according to claim 5, wherein the shaft fairing includes a trialing edge extending aft of the upper hub fairing and the lower hub fairing and the angled portion of the top surface extends to the trailing edge such that an overall height of the shaft fairing at the trailing edge is less than an overall height of the shaft fairing between the upper hub fairing and the lower hub fairing.

7. The rotor hub fairing according to claim 1, wherein the shaft fairing includes a trialing edge extending aft of the upper hub fairing and the lower hub fairing, at least a portion of the trailing edge being generally curved.

8. The rotor hub fairing according to claim 7, wherein the shaft fairing includes a top surface positioned adjacent the upper rotor hub and a portion of the top surface adjacent the trailing edge curves generally downward towards the lower hub fairing.

9. A coaxial rotor system comprising:
an upper rotor system including an upper rotor hub which rotates about an axis of rotation;
an upper hub fairing which at least partially surrounds a portion of said upper rotor hub;
a lower rotor system including a lower rotor hub which rotates about the axis of rotation;
a lower hub fairing which at least partially surrounds a portion of said lower rotor hub; and
a shaft fairing disposed between the upper hub fairing and the lower hub fairing, wherein a geometry of the shaft fairing is configured to encourage a wake adjacent the upper hub fairing to form collectively with a wake adjacent the lower hub fairing.
